(19) United States
(12) Patent Application Publication
(10) Pub. No.: US 2026/0313316 A1
(43) Pub. Date: Oct. 8, 2026

(54) ASSISTANCE USING PERIPHERAL DEVICES

(71) Applicant: QUALCOMM Incorporated, San Diego, CA (US)

(72) Inventors: Bapineedu Chowdary GUMMADI, Hyderabad (IN); Nicolas GRAUBE, Cambridge (GB); Avinash SHRIVASTAVA, Hyderabad (IN); Yibo ZHAO, Shanghai (CN); Zaiyong CHEN, Shanghai (CN); Zhaoming YANG, Shanghai (CN); Pulong XIE, Shanghai (CN); Yaqiong WANG, Shanghai (CN); Jiahui PAN, Shanghai (CN); Mozhou LIU, Shanghai (CN)

(21) Appl. No.: 19/482,132

(22) PCT Filed: Jun. 22, 2023
(86) PCT No.: PCT/CN2023/101994

§ 371 Date: Nov. 6, 2025

(51) Int. Cl. H04W 4/024

(52) U.S. Cl. CPC H04W 4/024

(57) ABSTRACT

Disclosed are systems, apparatuses, processes, and computer-readable media for wireless communications. For example, a wireless communication device can receive, from a network entity, instructions to display a navigation image associated with a path for a user to follow to arrive at a destination associated with one or more items in an environment. The wireless communication device can display the navigation image based on the instructions and movement of the user.

### FIELD OF THE DISCLOSURE

The present disclosure generally relates to wireless communications. For example, aspects of the present disclosure relate to providing assistance using wireless communication devices, such as peripheral devices (e.g., electronic shelf labels).

### BACKGROUND OF THE DISCLOSURE

Short range wireless communication enables wireless communication over relatively short distances (e.g., within thirty meters). For example, BLUETOOTH® is a wireless technology standard for exchanging data over short distances using short-wavelength ultra-high frequency (UHF) radio waves from 2.4 gigahertz (GHz) to 2.485 GHz.

BLUETOOTH® Low Energy (BLE) is a form of BLUETOOTH® communication that allows for communication with devices running on low power. Such devices may include beacons, which are wireless communication devices that may use low-energy communication technology for positioning, proximity marketing, or other purposes. In some cases, such devices may serve as nodes (e.g., relay nodes) of a wireless mesh network that communicates and/or relays information to a managing platform or hub associated with the wireless mesh network.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Systems and techniques are described for wireless communications. According to at least one illustrative example, a wireless communication device for wireless communication is provided. The wireless communication device includes a display, at least one memory, and at least one processor coupled to the at least one memory and the display. The at least one processor is configured to: receive, from a network entity, instructions to display a navigation image associated with a path for a user to follow to arrive at a destination associated with one or more items in an environment; and based on the instructions and movement of the user, cause the display to display the navigation image.

In another illustrative example, a method of wireless communication performed at a wireless communication device is provided. The method includes: receiving, by the wireless communication device from a network entity, instructions to display a navigation image associated with a path for a user to follow to arrive at a destination associated with one or more items in an environment; and displaying, by the wireless communication device based on the instructions and movement of the user, the navigation image on a display of the wireless communication device.

In another illustrative example, a non-transitory computer-readable storage medium of a wireless communication device is provided that includes instructions stored thereon which, when executed by at least one processor, causes the at least one processor to: receive, from a network entity, instructions to display a navigation image associated with a path for a user to follow to arrive at a destination associated with one or more items in an environment; and based on the instructions and movement of the user, cause a display to display the navigation image.

In another illustrative example, an apparatus for wireless communications is provided. The apparatus includes: means for receiving, from a network entity, instructions to display a navigation image associated with a path for a user to follow to arrive at a destination associated with one or more items in an environment; and means for displaying, based on the instructions and movement of the user, the navigation image on a display of the wireless communication device.

Aspects generally include a method, apparatus, system, computer program product, non-transitory computer-readable medium, user device, user equipment, wireless communication device, and/or processing system as substantially described with reference to and as illustrated by the drawings and specification.

Some aspects include a device having a processor configured to perform one or more operations of any of the methods summarized above. Further aspects include processing devices for use in a device configured with processor-executable instructions to perform operations of any of the methods summarized above. Further aspects include a non-transitory processor-readable storage medium having stored thereon processor-executable instructions configured to cause a processor of a device to perform operations of any of the methods summarized above. Further aspects include a device having means for performing functions of any of the methods summarized above.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims. The foregoing, together with other features and aspects, will become more apparent upon referring to the following specification, claims, and accompanying drawings.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

### BRIEF DESCRIPTION OF THE DRAWINGS

The accompanying drawings are presented to aid in the description of various aspects of the disclosure and are provided solely for illustration of the aspects and not limitation thereof. So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example environment in which systems and/or methods described herein may be implemented, in accordance with some aspects of the present disclosure.

FIG. 2 is a diagram illustrating example components of a device, in accordance with some aspects of the present disclosure.

FIG. 3 is a signaling diagram illustrating example communication transmissions, in accordance with some aspects of the present disclosure.

FIG. 4 is a flow chart illustrating an example of a process for providing assistance using wireless communication devices, such as electronic shelf labels (ESLs), in accordance with some aspects of the present disclosure.

FIG. 5 is a diagram illustrating examples of different direction symbol codes (or types) that may be employed for providing assistance using wireless communication devices, such as ESLs, in accordance with some aspects of the present disclosure.

FIG. 6 is a diagram illustrating an example of signaling that may be employed for providing assistance using wireless communication devices, such as ESLs, in accordance with some aspects of the present disclosure.

FIG. 7 is a diagram illustrating an example of a retail store environment with a robot that may be provided assistance by using wireless communication devices, such as ESLs, in accordance with some aspects of the present disclosure.

FIG. 8 is a diagram illustrating an example of a wireless communication device in the form of an electronic shelf label (ESL), in accordance with some aspects of the present disclosure.

FIG. 9 is a diagram illustrating an example of a wireless communication device in the form of an ESL including a coded image for providing assistance, in accordance with some aspects of the present disclosure.

FIG. 10 is a table showing examples of parameters for an operational code (opcode) for providing assistance using wireless communication devices, such as ESLs, in accordance with some aspects of the present disclosure.

FIG. 11 is a diagram illustrating an example of a retail store employed with wireless communication devices, such as ESLs, to provide assistance, in accordance with some aspects of the present disclosure.

FIG. 12A is a flow chart illustrating an example of a process for wireless communications at a wireless communication device, in accordance with some aspects of the present disclosure.

FIG. 12B is a flow chart illustrating an example of a process for wireless communications at a network entity, in accordance with some aspects of the present disclosure.

FIG. 13 is a block diagram illustrating an example of a computing system, which may be employed by the disclosed systems and techniques for providing assistance using wireless communication devices, such as ESLs, in accordance with some aspects of the present disclosure.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the scope of the application as set forth in the appended claims.

A system may include one or more wireless communication devices (e.g., peripheral devices) that are controlled by a network entity. For example, an electronic shelf label (ESL) system may include one or more wireless communication devices (e.g., peripheral devices, such as ESLs) that are controlled by a network entity, such as a management entity (ME), via at least one network device, such as an access point (AP). In one or more examples, to facilitate control by the management entity, each ESL may have a wireless connection (e.g., a BLUETOOTH® Low Energy (BLE) connection or other connection) to an AP that is communicatively connected to the ME (e.g., via the Internet, such as wirelessly, via an Ethernet connection, etc.). In some cases, commands from the ME may be wirelessly transmitted to the ESLs by the AP. Responses or information from the ESLs may also be received by the AP and provided by the AP to the ME. While examples are described herein using ESLs as illustrative examples of wireless communication devices, an ME as an example of a network entity, and APs as examples of network devices, the systems and techniques described herein are applicable to any type of system or network.

In some systems, such as ESL systems, periodic advertisements (PAs) are often utilized to provide regular and predictable payload transmissions from a network device, such as an access point, to one or more wireless communication devices, such as ESLs. For example, PAs can be used to issue information from a network device to multiple wireless communication devices, which may be within one or more groups of wireless communication devices. PAs are generally unidirectional (e.g., unidirectional transmissions) such that PAs are transmitted only one-way from a network device (e.g., access point) to one or more wireless communication devices (ESLs).

Periodic Advertisement with Response (PAwR) can be used for ESL systems to provide bidirectionality (e.g., bidirectional transmissions between a central device and one or more peripheral devices). Wireless communication devices (e.g., peripheral devices, such as ESLs) synchronized within a group of wireless communication devices can be addressed by a network device (e.g., AP) on a synchronized channel (e.g., a radio frequency (RF) channel between the network device and the wireless communication devices) whenever the network device chooses to send (e.g., transmit) a request to the wireless communication devices. In some cases, as used herein, a synchronized channel refers to a channel on which transmissions are synchronized (in time). For example, the channel includes a frequency on which one or more communications are transmitted. A hopping frequency sequence defines the channel, where the sequence progresses at a fixed determine interval. A central device and one or more peripheral devices can concurrently track the sequence at the predefined frequency hopping pattern (e.g., so the central device knows when to transmit the request and the peripheral devices know when to listen for and/or receive the request).

A request transmitted by a central device to peripheral devices in a particular group may be a PA containing a synchronization message transmitted by the central device on the synchronized channel to the peripheral devices of the particular group. For example, wireless communication devices within the particular group can wake up (e.g., from a low power (LP) mode) at the same PA transmission with respect to a particular PAwR train for that group. A PA is made up of a periodic set of transmissions, where the collection of transmissions is collectively referred to as a PA train or a PAwR train when applied to PAwR. Each transmission of a PA train (or PAwR train) occurs at a precise point in time, with fixed intervals between the transmissions. A communication channel (e.g., one communication channel out of thirty-seven available communication channels) is selected for each of the transmissions, where the communication channel follows a hopping frequency sequence. The synchronization between the central device and the peripheral devices in the group is based on the periodicity of the PA. The periodically-transmitted messages (e.g., the synchronization messages) include zero, one, or more commands (e.g., a respective operational code (OpCode) and parameters associated with each command). If a response from a wireless communication device is expected by the network device (e.g., the synchronization message from the network device requests a response from a specific wireless communication device), the particular wireless communication device will respond in a specific response slot, which may be based on where the wireless communication device appeared within a sequence contained within the synchronization message transmitted by the network device.

ESL systems can be deployed to support and manage ESL devices in stores (e.g., supermarkets) and in industrial warehouses. For example, in stores, ESLs can be employed as electronic labels that are affixed to store shelves to identify the items and the price of the items located on the store shelf above the label. ESLs may be each implemented with a display (e.g., a liquid crystal display (LCD), an electronic paper (e-paper) display, etc.). The ESL may digitally display the name of the item, a product identification number for the item, such as a stock keeping unit (SKU) number, and a price for the item. The ESL may additionally display a barcode for the item, a quick response (QR) code for the item, and/or an image (e.g., a picture) of the item. During operation of the ESL system, the information displayed on the ESLs may be updated periodically by using PAs.

As previously mentioned, the infrastructure for an ESL system can include one or more management entities (MEs) and one or more access points (APs). A ME is generally a software solution (e.g., which may run on a cloud server or other computing device), where information (e.g., details related to a product or service) to be displayed on the ESL can be determined, stored, and sent to the ESL (e.g., via an AP) for display on the ESL. An AP is generally a communication device, which can communicate with both MEs and ESLs, and can relay information from an ME to an ESL.

An AP can receive information (e.g., details related to a product or service) from an ME to be displayed on an ESL. The AP can connect to an ESL, and transfer this received information from the ME to the ESL to be displayed on the ESL. An ESL is generally a hardware device that can display the details (e.g., product details) it receives from the AP that the ESL is connected. The details (e.g., product details, such as price) displayed on the ESL can be dynamically changed and controlled by the ME. ESLs can be extended to commercial spaces (e.g., supermarkets, home improvements stores, industrial warehouses, office buildings government buildings, institutional buildings, and/or offices) to display details related to products or employees. ESLs are power efficient (e.g., by using BLE), and very convenient to maintain (e.g., easy to update details) as compared to traditional paper shelf labels for products in stores.

Users (or customers) in stores (e.g., supermarkets, home improvement stores, and/or warehouse stores) often have to search to locate a desired item (product) in the store. When the store is large, in order to locate an item, a user (customer) may need to search a large area for a long time, which can be very inconvenient for the user. As such, an improved technique for assisting users for quickly locating items within a store can be beneficial.

Currently, robotics is becoming an essential part of the modern retail industry. Retail robots (e.g., robotic employees) are promising because of their ability to free up workers (e.g., human employees) from their routine tasks. Some of these routine tasks can include merchandise (e.g., product) replenishment and/or replacement. With the use of expensive hardware and complex algorithms, robots are capable of interpreting the retail space of a store and reconstructing a plan-o-gram for the store. In this way, a robot is able to find its way from a warehouse area located inside the retail store to the exact shelf in the retail space of the store for replenishing and/or replacing products that are out of date or expired.

However, robots need to be able to compute the path to the goods and to locate the goods by themselves, which can require expensive hardware and/or location systems. These expensive hardware and/or location systems can lead to a high cost for the robot. Even when using expensive sophisticated robots, due to the complexity of retail store, the path computed by these robots can be wrong or inaccurate and, as such, the efficiency for replenishment and/or replacement of products can be impacted. As such, an improved technique, which is low cost and efficient, for assisting robots for replacing and/or replenishing products within a store can be beneficial.

In one or more aspects of the present disclosure, systems, apparatuses, methods (also referred to as processes), and computer-readable media (collectively referred to herein as “systems and techniques”) are described herein that provide assistance using wireless communication devices, such as peripheral devices (e.g., ESLs). For example, the systems and techniques can provide assistance to users (e.g., customers) in an environment (e.g., a warehouse, a store, an office building, etc.) for locating items within the environment by utilizing wireless communication devices (e.g., peripheral devices, such as ESLs).

In one or more examples, the wireless communication devices (e.g., ESLs) can display navigation images (e.g., such as in the form of one or more direction symbols, such as a right arrow, a left arrow, an up arrow, a down arrow, any combination thereof, and/or other direction symbols) to one or more users within an environment (e.g., a warehouse, a store, an office building, etc.) to guide the user(s) throughout the environment to quickly and efficiently locate a desired item(s) (e.g., to locate an item in a store). In some examples, the wireless communication devices (e.g., ESLs) can display navigation images for one or more supervisors within an office building (or warehouse, store, etc.) to guide the supervisor(s) throughout the office building (or warehouse) to locate an employee(s). In one or more examples, the wireless communication devices (e.g., ESLs) can display navigation images for one or more users within a building to locate different features of the building that may include, but are not limited to, stairs, elevators, escalators, billing counters, and/or water fountains.

In some aspects, the systems and techniques can provide assistance to robots (e.g., robotic employees) in an environment (e.g., a warehouse, a store, an office building, etc.) for performing one or more functions with respect to the environment (e.g., replacing and/or replenishing items (e.g., products) within a warehouse, store, etc.) by utilizing wireless communication devices, such as peripheral devices (e.g., ESLs). In one or more examples, the systems and techniques provide a low cost and efficient solution employing an ESL infra-structure (e.g., an ESL system) to navigate robots to complete routine tasks, such as replenishment and/or replacement of products within a retail store. In some cases, the wireless communication devices (e.g., ESLs) can display navigation images (e.g., such as a coded image, in the form of a quick response (QR) code, associated with coded instructions) to one or more robots within the environment to guide the robot(s) throughout the store to quickly and efficiently perform a task (e.g., to replenish and/or replace products within a store). The systems and techniques have the advantage of not requiring the robot to have an on-boarded location system or any other kind of autonomous location system, which can be expensive. For the systems and techniques, a vision system on-boarded onto robot is sufficient.

While aspects and examples are described herein using customers of a store as illustrative examples of users and robots as illustrative examples of assistants that may receive instructions via the ESLs implemented using the systems and techniques described herein, the systems and techniques can apply to other types of users (e.g., employees in a warehouse, patrons of an amusement park, etc.) and assistants (e.g., other types of electronic devices).

Additional aspects of the present disclosure are described in more detail below.

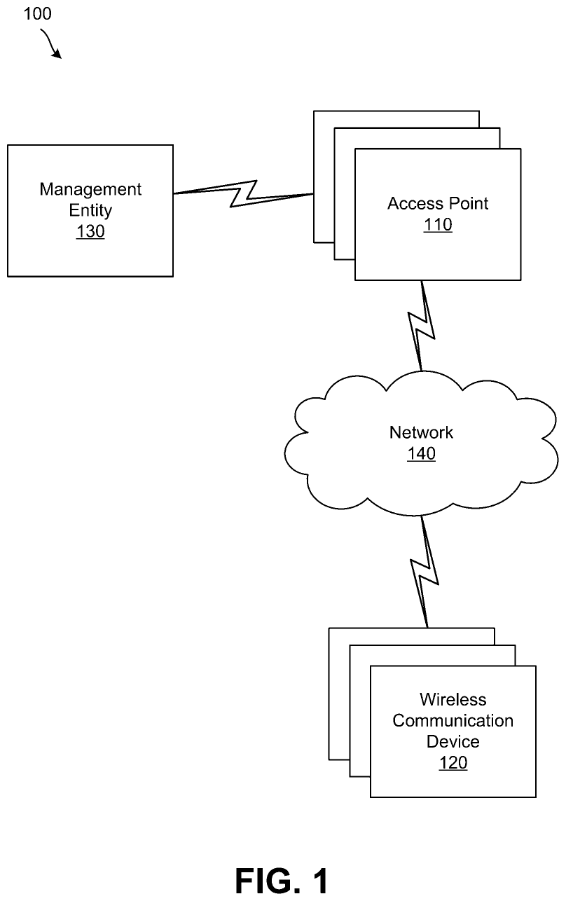

FIG. 1 is a diagram of an example environment 100 in which systems and/or methods described herein may be implemented. As shown in FIG. 1, the environment 100 may include at least one access point (AP) 110, at least one wireless communication device 120, a management entity (ME) 130, and a network 140. Devices of the environment 100 may interconnect via wired connections, wireless connections, or a combination of wired and wireless connections.

The access point 110 may include one or more devices capable of receiving, generating, storing, processing, providing, and/or routing information associated with access point synchronization and/or handover, as described elsewhere herein. The access point 110 may include a communication device and/or a computing device. The access point 110 may be configured to transmit beacons (e.g., BLE beacons), as well as to scan and locate other devices (e.g., other devices communicating using BLE protocols).

The wireless communication device 120 may include one or more devices capable of receiving, generating, storing, processing, and/or providing information associated with access point synchronization and/or handover, as described elsewhere herein. The wireless communication device 120 may include a communication device and/or a computing device. In some aspects, the wireless communication device 120 may be, may include, or may be included in an electronic shelf label (ESL).

The management entity 130 includes one or more devices capable of receiving, generating, storing, processing, providing, and/or routing information associated with access point synchronization and/or handover, as described elsewhere herein. The management entity 130 may include a communication device and/or a computing device. For example, the management entity 130 may include a server, such as an application server, a client server, a web server, a database server, a host server, a proxy server, a virtual server (e.g., executing on computing hardware), or a server in a cloud computing system. In some aspects, the management entity 130 includes computing hardware used in a cloud computing environment. The management entity 130 may provide control of a system (e.g., an ESL system) that includes the access point(s) 110, the wireless communication device(s) 120, and/or the device(s) 130. The access point(s) 110 may be communicatively connected to the management entity 130 via a network (not shown), such as the Internet.

The network 140 may include one or more wireless networks. For example, the network 140 may include a personal area network (e.g., a Bluetooth network). The network 140 enables communication among the devices of environment 100.

The number and arrangement of devices and networks shown in FIG. 1 are provided as an example. In practice, there may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) of environment 100 may perform one or more functions described as being performed by another set of devices of environment 100.

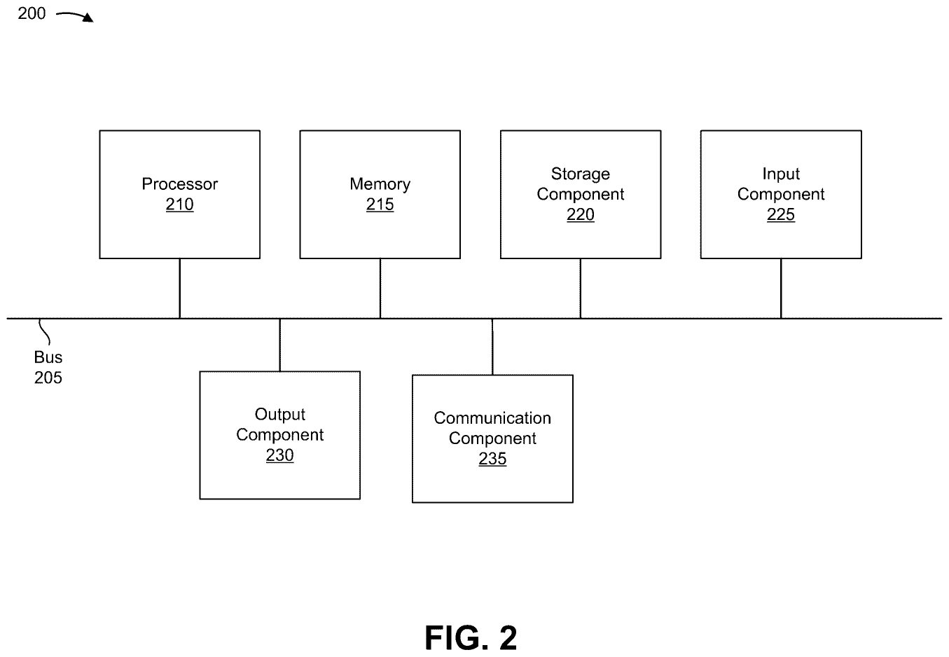

FIG. 2 is a diagram illustrating example components of a device 200, in accordance with the present disclosure. Device 200 may correspond to access point 110, wireless communication device 120, and/or management entity 130. In some aspects, access point 110, wireless communication device 120, and/or management entity 130 may include one or more devices 200 and/or one or more components of device 200. As shown in FIG. 2, device 200 may include a bus 205, a processor 210, a memory 215, a storage component 220, an input component 225, an output component 230, and/or a communication component 235.

Bus 205 may include a component that permits communication among the components of device 200. Processor 210 may be implemented in hardware, firmware, or a combination of hardware and software. Processor 210 may be a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some aspects, processor 210 may include one or more processors capable of being programmed to perform a function. Memory 215 may include a random access memory (RAM), a read only memory (ROM), and/or another type of dynamic or static storage device (e.g., a flash memory, a magnetic memory, and/or an optical memory) that stores information and/or instructions for use by processor 210.

Storage component 220 can store information and/or software related to the operation and use of device 200. For example, storage component 220 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

Input component 225 may include a component that permits device 200 to receive information, such as via user input (e.g., a touch screen display, a keyboard, a keypad, a mouse, a button, a switch, and/or a microphone). Additionally, or alternatively, input component 225 may include a component for determining a position or a location of device 200 (e.g., an indoor location component or system that can be based on a plan-o-gram of an environment in which the device 200 is located, a global positioning system (GPS) component, a global navigation satellite system (GNSS) component, any combination thereof, and/or other location component) and/or a sensor for sensing information (e.g., an accelerometer, a gyroscope, an actuator, or another type of position or environment sensor). Output component 230 can include a component that provides output information from device 200 (e.g., a display, a speaker, a haptic feedback component, and/or an audio or visual indicator).

Communication component 235 may include one or more transceiver-like components (e.g., a transceiver and/or a separate receiver and transmitter) that enables device 200 to communicate with other devices, such as via a wired connection, a wireless connection, or a combination of wired and wireless connections. Communication component 235 may permit device 200 to receive information from another device and/or provide information to another device. For example, communication component 235 may include an Ethernet interface, an optical interface, a coaxial interface, an infrared interface, a radio frequency interface, a universal serial bus (USB) interface, a wireless local area interface (e.g., a Wi-Fi interface or a BLE interface), and/or a cellular network interface.

Communication component 235 may include one or more antennas for receiving wireless radio frequency (RF) signals transmitted from one or more other devices, cloud networks, and/or the like. The antenna may be a single antenna or an antenna array (e.g., antenna phased array) that can facilitate simultaneous transmit and receive functionality. The antenna may be an omnidirectional antenna such that signals can be received from and transmitted in all directions. The wireless signals may be transmitted via a wireless network. The wireless network may be any wireless network, such as a cellular or telecommunications network (e.g., 3G, 4G, 5G, etc.), wireless local area network (e.g., a WiFi network), a Bluetooth™ network, and/or other network.

The one or more transceiver-like components (e.g., a wireless transceiver) of the communication component 235 may include an RF front end including one or more components, such as an amplifier, a mixer (also referred to as a signal multiplier) for signal down conversion, a frequency synthesizer (also referred to as an oscillator) that provides signals to the mixer, a baseband filter, an analog-to-digital converter (ADC), one or more power amplifiers, among other components. The RF front-end can generally handle selection and conversion of the wireless signals into a baseband or intermediate frequency and can convert the RF signals to the digital domain.

In some cases, a CODEC may be implemented (e.g., by the processor 210) to encode and/or decode data transmitted and/or received using the one or more wireless transceivers. In some cases, encryption-decryption may be implemented (e.g., by the processor 210) to encrypt and/or decrypt data (e.g., according to the Advanced Encryption Standard (AES) and/or Data Encryption Standard (DES) standard) transmitted and/or received by the one or more wireless transceivers.

In some aspects, device 200 may represent an ESL. The ESL may include a battery in addition to the aforementioned components. In some aspects, the output component 230 of the ESL may be an electronic paper (e-paper) display or a liquid crystal display (LCD).

Device 200 may perform one or more processes described herein. Device 200 may perform these processes based on processor 210 executing software instructions stored by a non-transitory computer-readable medium, such as memory 215 and/or storage component 220. A computer-readable medium is defined herein as a non-transitory memory device. A memory device includes memory space within a single physical storage device or memory space spread across multiple physical storage devices.

Software instructions may be read into memory 215 and/or storage component 220 from another computer-readable medium or from another device via communication component 235. When executed, software instructions stored in memory 215 and/or storage component 220 may cause processor 210 to perform one or more processes described herein. Additionally, or alternatively, hardwired circuitry may be used in place of or in combination with software instructions to perform one or more processes described herein. Thus, aspects described herein are not limited to any specific combination of hardware circuitry and software.

The number and arrangement of components shown in FIG. 2 are provided as an example. In practice, device 200 may include additional components, fewer components, different components, or differently arranged components than those shown in FIG. 2. Additionally, or alternatively, a set of components (e.g., one or more components) of device 200 may perform one or more functions described as being performed by another set of components of device 200.

As previously mentioned, in ESL systems, PAs are often utilized to provide regular and predictable payload transmissions from a network device, such as an access point, to one or more wireless communication devices, such as ESLs. PAs can be used to issue information from a network device to multiple wireless communication devices, which may be within one or more groups of wireless communication devices. PAs are generally unidirectional (e.g., unidirectional transmissions) such that PAs are transmitted only one-way from a network device (e.g., access point) to one or more wireless communication devices (ESLs).

Periodic Advertisement with Response (PAwR) was introduced to ESL systems to provide bidirectionality (e.g., bidirectional transmissions between a network device, such as an access point, and one or more wireless communication devices, such as ESLs). Wireless communication devices (e.g., ESLs) synchronized within a group of wireless communication devices can be addressed by a network device (e.g., AP) on a synchronized channel (e.g., a synchronized frequency channel between the network device and the wireless communication devices) whenever the network device chooses to send (e.g., transmit) a request (e.g., a PA containing a synchronization message transmitted on the synchronized channel) to the wireless communication devices. If a response from a wireless communication device is expected by the network device (e.g., the synchronization message from the network device requests a response from a specific wireless communication device), the particular wireless communication device will respond in a specific response slot, which may be based on where the wireless communication device appeared within a sequence contained within the synchronization message transmitted by the network device.

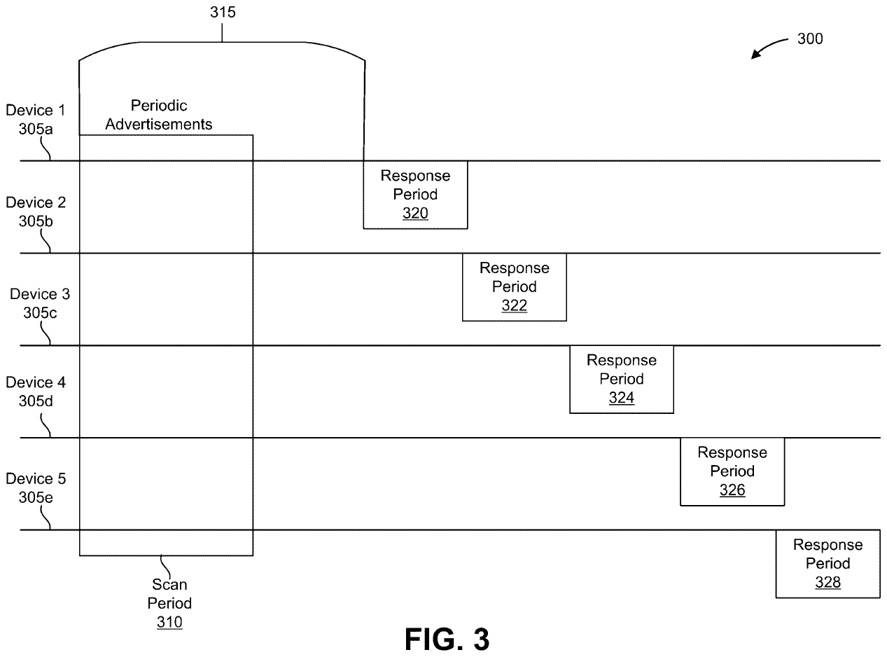

FIG. 3 shows a signaling diagram 300 illustrating examples of PAwR in an ESL system including a group of wireless network devices (e.g., device 1 305a, device 2 305b, device 3 305c, device 4 305d, and device 5 305e). In particular, FIG. 3 is a signal timing diagram illustrating a portion of a communication between a network device (e.g., an access point, such as access point 110 of FIG. 1) and wireless communication devices (e.g., wireless communication devices 120 of FIG. 1, some or all of which may be in the form of ESLs). As such, with reference to FIG. 1, the signal sequence illustrated in FIG. 3 may be implemented by one or more of the communication connections, access points 110, and/or wireless communication devices 120 of FIG. 1.

The devices (e.g., device 1 305a, device 2 305b, device 3 305c, device 4 305d, and device 5 305e) of FIG. 3 may be selected from wireless communication devices 120 of FIG. 1, and may each receive a periodic advertisement (PA) in a scan period 310. The scan period 310 may occur in regularly scheduled intervals and may be repeated periodically such that the devices (e.g., device 1 305a, device 2 305b, device 3 305c, device 4 305d, and device 5 305e) can awaken to scan for messages during this repeated scan period 310. An access point (e.g., access point 110 of FIG. 1) may provide periodic advertisements (PAS) via broadcast or multi-cast to the devices (e.g., device 1 305a, device 2 305b, device 3 305c, device 4 305d, and device 5 305e) in the scan period 310. For an access point (e.g., access point 110 of FIG. 1), the scan period 310 can be its primary transmission period. In some cases, the scan period 310 may not be a fixed time because the access point (e.g., access point 110 of FIG. 1) may send different lengths of data from the start of the scan period 310.

The transmission may include multiple advertisements in a train (e.g., a PA train or PAWR train). One or more portions of the advertisements may be directed to one or more of the devices (e.g., device 1 305a, device 2 305b, device 3 305c, device 4 305d, and device 5 305e). The devices (e.g., device 1 305a, device 2 305b, device 3 305c, device 4 305d, and device 5 305e) may decode or filter the messages intended for each specific device and transmitted during the period when all devices are receiving. In this way, the devices (e.g., device 1 305a, device 2 305b, device 3 305c, device 4 305d, and device 5 305e) may be reprogrammed, updated, and/or sent requests from an access point (e.g., access point 110 of FIG. 1) or relayed from another device (e.g., management entity 130 of FIG. 1) through the access point (e.g., access point 110 of FIG. 1). The periodic advertisement (PA) from the access point (e.g., access point 110 of FIG. 1) may set a response period for one or more of the devices (e.g., device 1 305a, device 2 305b, device 3 305c, device 4 305d, and device 5 305e).

As illustrated, the devices (e.g., device 1 305a, device 2 305b, device 3 305c, device 4 305d, and device 5 305e) are each assigned a response period 320, 322, 324, 326, 328 in the time after the scan period 310. The first response period 320 may begin following an idle time 315 after the scan period 310, with the idle period being long enough to provide the transmitter device an opportunity to do other Bluetooth related activities. The assigned response periods may also be limited to or designate a particular frequency of the channels on which to respond. For example, in FIG. 3, device 1 305a is assigned response period 320, device 2 305b is assigned response period 322, device 3 305c is assigned response period 324, device 4 305d is assigned response period 326, and device 5 305e is assigned response period 328. The access point (e.g., access point 110 of FIG. 1) may store attributes of the devices (e.g., device 1 305a, device 2 305b, device 3 305c, device 4 305d, and device 5 305e), including whether a device is able to transmit or respond. The PA signaling followed by responses can be referred to as periodic advertisement with multiple responses (PAwMR).

For example, device 3 305c (e.g., wireless communication device 120 of FIG. 1) may be an ESL and may receive a price update in a PA from the access point (e.g., access point 110 of FIG. 1) in scan period 310. The PA received at device 3 305c may include a designated start time for the response period 324 or may include a schedule of response start times for devices including device 3 305c. The response by device 3 305c to the access point (e.g., access point 110 of FIG. 1) may include an acknowledgement, a status code, and/or other information such as battery life, received signal strength, and/or an error notification. The response by device 3 305c may include information to be relayed to another device by the access point (e.g., access point 110 of FIG. 1). The response may include a packet with a header and may conform to any of the Bluetooth protocols. A response may be transmitted in a data channel of the Bluetooth protocol to the access point (e.g., access point 110 of FIG. 1). Both the PA and the responses from all of the devices (e.g., device 1 305a, device 2 305b, device 3 305c, device 4 305d, and device 5 305e) may use channels of the Bluetooth protocol.

A device (e.g., device 5 305e) that has been assigned a response period may not respond and may determine that it has nothing to signal. In other words, the devices (e.g., device 1 305a, device 2 305b, device 3 305c, device 4 305d, and device 5 305e) may determine what response, if any, is required and may or may not respond to a request sent from the access point (e.g., access point 110 of FIG. 1). The response periods 320, 322, 324, 326, 328 may be assigned based on a request for such a period in an open transmission time, the request being sent to the access point (e.g., access point 110 of FIG. 1). The response periods 320, 322, 324, 326, 328 may be assigned based on which devices have been requested by the access point (e.g., access point 110 of FIG. 1) to send data or acknowledgements. The PA messages and responses may be frequency-hopped, time synchronized channels, and/or extended channels of the advertising channels in Bluetooth.

As previously mentioned, currently, ESL systems can be deployed to support and manage ESL devices in various types of environments, such as stores (e.g., supermarkets), warehouses (e.g., industrial warehouses), office buildings, among other environments. Using stores as an illustrative example, ESLs can be employed as electronic labels that are affixed to store shelves to identify the items and the price of the items located on the store shelf above the label. ESLs can be each implemented with a a display (e.g., a liquid crystal display (LCD), an electronic paper (e-paper) display, etc. The ESL can digitally display a name of the item, a product identification number for the item (e.g., a SKU number), a price for the item, a barcode for the item, a quick response (QR) code for the item, an image (e.g., a picture) of the item, any combination thereof, and/or other information. During operation of the ESL system, the information displayed on the ESLs can be updated periodically, such as by using PAS.

The infrastructure for an ESL system may include one or more management entities (MEs) and one or more access points (APs). As noted herein, an ME (e.g., a network entity) can be a software solution (e.g., running on a cloud server), where information (details) to be displayed on the ESL may be determined, stored, and sent to the ESL (via an AP) for display on the ESL. An AP (e.g., a network device) can be a communication device that can communicate with both MEs and ESLs, and can relay information from an ME to an ESL.

An AP may receive information (e.g., details) from an ME to be displayed on an ESL. The AP can connect to an ESL, and transfer (e.g., transmit) information received from the ME to the ESL to be displayed on the ESL. The ESL can be a hardware device that can display the details it receives from the AP that the ESL is connected, such as the information noted above (e.g., name of the item, a product identification number for the item, barcode, QR code, product details, price, etc.). The details displayed on the ESL can be dynamically changed (e.g., updated) and controlled by the ME. ESLs can be used in various environments (e.g., supermarkets, home improvements stores, industrial warehouses, office buildings government buildings, institutional buildings, offices, and/or other types of environments) to display details related to the environments, such as products in the environment, people (e.g., employees, managers, guests) in the environment, etc. ESLs are power efficient by employing BLE, and very convenient to maintain (e.g., easy to update details), as compared to traditional paper shelf labels for products in stores.

Users within an environment often have to search to locate a desired item or location within the environment. For example, users (e.g., persons, such as customers) in stores (e.g., supermarkets, home improvement stores, warehouse stores, etc.) may have to search to locate a desired item (e.g., a product) in the store. When the store is large, in order to locate an item, a user (or customer) may need to search a large area for a long time, which can be very inconvenient for the user. As such, improved systems and techniques for assisting users for quickly navigating an environment (e.g., locating items within a store, warehouse, office space, etc.) can be useful.

As noted previously, systems and techniques are described herein for providing assistance using wireless communication devices, such as peripheral devices (e.g., ESLs). For example, the systems and techniques can provide assistance to users (e.g., customers, workers, employees, etc.) in an environment (e.g., a warehouse, a store, an office building, etc.) for locating items within the environment by utilizing wireless communication devices (e.g., peripheral devices, such as ESLs). In one or more examples, the wireless communication devices (e.g., ESLs) can display navigation images (e.g., direction symbols, such as a right arrow, a left arrow, an up arrow, a down arrow, a diagonal arrow, any combination thereof, and/or other direction symbols) to one or more users within a store to guide the user(s) throughout the store to quickly and efficiently locate a desired item(s).

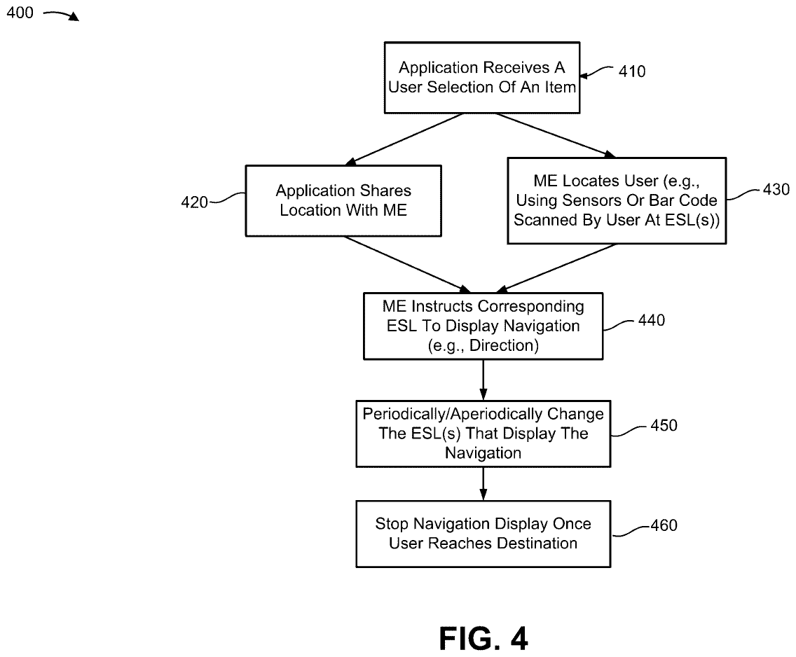

FIG. 4 shows an example of a process 400 for providing a user (e.g., a customer) with assistance for locating a product within a store using wireless communication devices (e.g., wireless communication devices 120 of FIG. 1, such as ESLs). For example, the ESLs can assist a user (e.g., customer) to locate an item (e.g., a product) of interest to the user in a retail stores space by providing the user with navigation images to quickly and efficiently locate the item.

During operation of the process 400, at block 410, an application can receive user input from a user device (e.g., a personal electronic device, such as a mobile phone, a wearable device, or other user device) based on a user (e.g., customer) selecting an item (e.g., product) of their choice (e.g., by using an application running on the user device). At block 420, the application can share the location of the user with an ME (e.g., a software solution running on a cloud server). At block 430, the location of the user can be detected (determined) by various different location methods, and the ME and AP can then be aware of the location of the user within the store. Examples of the location methods that can be employed to locate the user within the store can include, but are not limited to, obtaining the location of the user's electronic device (e.g., smart phone) through the use of one or more positioning technologies (e.g., based on a global positioning system (GPS), global navigation satellite system (GNSS), etc.), by using sensors located at various different positions within the store, and/or by the user scanning with their electronic device (e.g., smart phone) a barcode or QR code on an ESL (or multiple barcodes or QR codes on multiple ESLs) in the store through which the ME can obtain the location for the user (e.g., the ME can determine a known location of an ESL on which a barcode was scanned using the user's electronic device, and use the known location of the ESL as the user's location).

At block 440, based on the location of the user, the ME can instruct one or more ESLs located in close proximity to the user to display navigation instructions (e.g., directions for navigation through the store, such as by displaying arrows pointing in a particular direction or in multiple directions, such as indicating a forward direction followed by a right turn) designating the direction(s) to the desired product within the store. In one illustrative example, the ESLs located in close proximity to the user can switch to running in a “direction assistance mode”, and can indicate (e.g., by displaying on the display of the ESL) the direction(s) (e.g., through the use of displaying arrows) to the desired product within the store. The ESLs within the store displaying the directions can be limited to only a certain number of ESLs in some cases, such as ESLs that are located in close proximity to the user.

At block 450, the ESLs displaying navigation information (e.g., directions or other navigation images) can change periodically or aperiodically. For example, the ESLs displaying directions can change based on periodicity (e.g., periodically), where X number of ESLs (e.g., a first set of ESLs) can display the directions at time T, and the next following set of X number of ESLs (e.g., a second set of ESLs) can display the directions after time T+t until time T+2d, during which the first X number of ESLs (e.g., the first set of ESLs) can switch back to a default display mode no longer displaying the directions. The process of displaying can repeat using subsequent sets of ESLs. In one or more examples, ESLs within a set of ESLs (e.g., X number of ESLs) can be staggered to display the direction(s) (e.g., navigation image) across multiple time periods (e.g., in a kind of hysteresis fashion).

For another example, the ESLs displaying the navigation (e.g., directions or other navigation images) can change based on the user's motion (e.g., aperiodically). The user's location and/or motion can be updated to the ME and/or AP by the user's device or by sensors (e.g., cameras and/or visible light communication (VLC) based positioning sensors) located throughout the store. Based on the location update for the user, the displays of the ESLs can change to display directions, when the user is located in close proximity to the ESLs. Using the user's location and/or motion to trigger the ESLs to display directions can cause the ESLs display directions for a longer period of time, when the user is moving slowly, or for a shorter period of time, when the user is moving fast.

In one or more examples, the ESLs can include preloaded data or material (e.g., data related to the directional arrow icons or symbols) to display the directions (e.g., navigation images). Since the ESLs are preloaded with the data, the ESLs will not need to download the material, which can take several seconds for the download.

In some examples, the direction(s) (e.g., left arrow, right arrow, up arrow, any combination thereof, and/or other direction(s)) displayed by each ESL need not be based on the shortest route for the user to take to reach the product, but might be based on the route to the product that is less crowded than the shortest route. Some routes to the product may be blocked or slow, due to crowds of customers shopping within the aisles and/or products on pallets within the aisles being stocked (replenished) by employees working within the aisles. In one or more examples, some routes for the users to reach the products may be chosen such that the users are routed by certain products (e.g., items that are on sale, or items that are targeted for sale to specific types of users). At block 460, the ESLs can stop displaying the navigation information (e.g., directional images or other navigation images), once the user reaches the location of the desired product within the store.

In one or more aspects, when the store is crowded with users (e.g., customers), there may be requests from multiple users at the same time. In this scenario, a single ESL may need to display multiple directions (e.g., navigation images) for multiple users. In order for the multiple directions displayed on an ESL to not be confusing to the users, a specific direction symbol code (or type) and/or specific color for one or more directions symbol can be assigned to each individual user (e.g., for a specific time period). In some cases, there may be an upper limit for the number of users that can be served by each ESL for providing directions, for the number of different direction symbol codes that can be displayed by each ESL, and/or for the number of different colors that can be displayed by each ESL. In one or more examples, an ESL can display the directions (e.g., navigation images) for each customer successively (e.g., the ESL can change the color and/or direction symbol code for each user every 1 second). In some examples, an ESL can simultaneously display the color and/or direction symbol for the users served by the ESL.

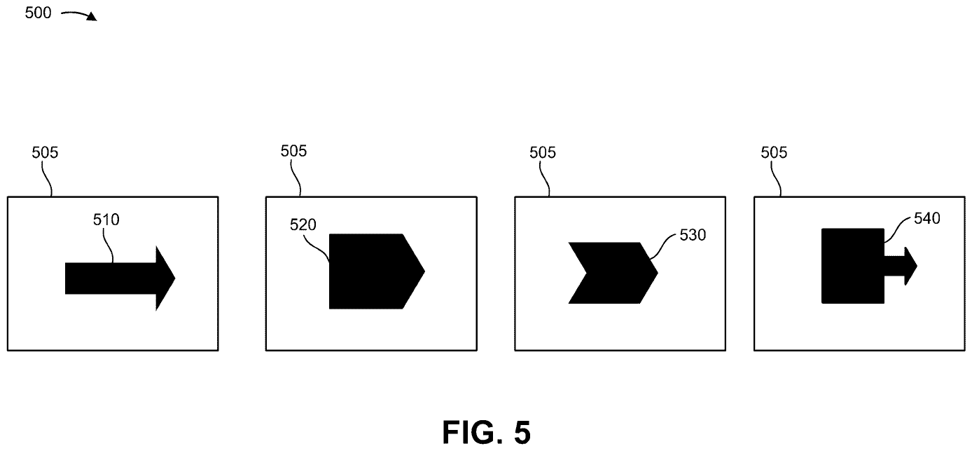

FIG. 5 shows examples of different direction symbol codes that may be assigned to different users and displayed by an ESL 505. In particular, FIG. 5 is a diagram illustrating examples 500 of different direction symbol codes (or types) 510, 520, 530, 540 that may be employed for providing assistance using wireless communication devices, such as ESLs. In FIG. 5, the direction symbol codes 510, 520, 530, 540 are all right arrow direction symbols indicating that a user should travel in a right direction to locate the desired product. Each direction symbol code 510, 520, 530, 540 may be assigned to a different user. In one or more examples, the different direction symbol codes 510, 520, 530, 540 may be displayed as having the same color or different colors.

In one or more examples, wireless communication devices (e.g., ESLs) can display directional navigation images for one or more supervisors (e.g., persons) within an office building (or warehouse) to guide the supervisor(s) throughout the office building (or warehouse) to locate an employee(s) (e.g., person(s)). For these examples, the process for locating an employee within an office building (or warehouse) can be similar to the process 400 of FIG. 4 for locating a desired product within a store.

In one or more examples, wireless communication devices (e.g., ESLs), which may be located within edges and/or corners of a building, may display directional navigation images for one or more users (e.g., customers and/or employees) within a building to locate different features of the building. Different features of the building may include, but are not limited to, stairs, elevators, escalators, billing counters, and/or water fountains. In some examples, the ESLs can display directions (e.g., navigation images) to the features statically for a short amount of time (e.g., every X number of seconds), or dynamically when a user (e.g., a customer or employee) is detected to be located in close proximity (e.g., adjacent) to the ESL. Since these features are often located within a certain region (e.g., north corner) of the building, when a user is able to locate one or more of these features in the building, the user is able to realize their location within the building.

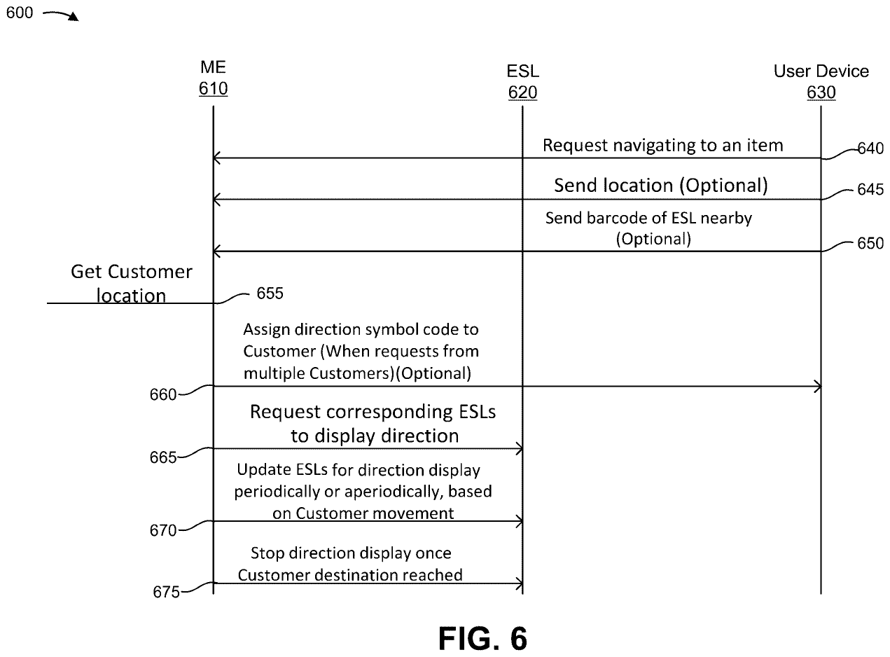

FIG. 6 is a diagram illustrating an example of signaling 600 for assisting a user to locate a desired item (e.g., product, feature, or employee) within a building (e.g., retail store or office building). For example, the signaling 600 of FIG. 6 can be employed for providing assistance using wireless communication devices, such as ESLs. In FIG. 6, a ME 610, an ESL 620, and a user device 630 (e.g., customer).

During operation, a user device 630 can send a request 640 (e.g., based on a user providing input to the user device to make the request 640, such as using an application running in the user device) to the ME 610 for navigating (e.g., locating) a desired item. Optionally, the user device 630 can send to the ME 610 (e.g., via an application running in the user's personal electronic device) the user's current location 645. The user device 630 can also, optionally, send to the ME 610 a barcode of a nearby ESL 650 by scanning a barcode displayed on that ESL with the user's personal electronic device.

Once the ME 610 receives the request and any other additional information from the user device 630, the ME 610 can obtain (e.g., determine) the location 655 of the user device 630. For instance, the ME 610 can obtain (e.g., determine) the location 655 of the user device 630 using any suitable location method, such as by obtaining the location of the user device 630 through the use of one or more positioning technologies (e.g., based on a global positioning system (GPS), global navigation satellite system (GNSS), etc.), by using sensors located at various different positions within the store, and/or by the user scanning with user device 630 a barcode or QR code on an ESL (or multiple barcodes or QR codes on multiple ESLs) in the store through which the ME can obtain the location for the user (e.g., the ME can determine a known location of an ESL on which a barcode was scanned using the user device 630, and use the known location of the ESL as the location of the user device 630 and/or the user's location).

After the ME 610 obtains the location of the user device 630, the ME 610 can assign a direction symbol code 660 to the user device 630 (e.g., in scenarios where the ME 610 receives requests from multiple different users). The ME 610 can request 665 corresponding ESLs 620 (e.g., ESLs located in close proximity to the user device 630) to display direction symbols (e.g., navigation images) indicating one or more directions for the user device 630 to travel to locate the desired item. The ME 610 can then update the ESLs 620 (e.g., ESLs located in close proximity to the user device 630) to display the directions (e.g., navigation images) periodically or aperiodically 670 based on the user's 630 movement. The ME 610 can then stop the ESLs 620 from displaying the directions (e.g., navigation images) at operation 675, once the user device 630 has reached the destination location of the desired item.

In one or more aspects, a ME can perform a variety of different tasks to assist a user (e.g., a customer). In one or more examples, an ME can receive a request from a user device (e.g., a mobile phone, a wearable device, or other user device) of a user (e.g., customer) to locate a desired item. In some examples, the ME can estimate the locations of the ESLs in the store by using received signal strength indicator (RSSI) measurements sent by the ESLs along with a floor map of the store, which is available to the ME. The ME can receive or estimate the location of the user, and instruct the ESLs (e.g., located within close proximity of the user) to display directions (e.g., navigation images) for the user to follow to locate the desired items. In scenarios where an ME receives requests from multiple users to locate items, the ME can assign a color and/or direction symbol code to each user, and instruct the ESLs (e.g., located within close proximity of the users) to display the assigned color and/or direction symbol code for the users.

In one or more aspects, an ESL can perform a variety of different tasks to assist a user. In one or more examples, an ESL can display a direction symbol (e.g., a navigation image) or multiple direction symbols to assist the user in navigating throughout the store (or building) to locate a desired item. An ESL can cease displaying its standard default display, and display one or more direction symbols (e.g., navigation image) statically for a short amount of time, or dynamically based on the user's movement within the store. In some examples, an ESL can display direction symbol while simultaneously displaying its standard default display. In one or more examples, an ESL may already have downloaded onto it the material (e.g., data) for its standard default display. In some scenarios, where multiple users request assistance for locating desired items, an ESL can display directions (e.g., navigation images) for each of the users individually by simultaneously displaying a specific color and/or direction symbol code(s) assigned for each of the users.

As noted previously, systems and techniques are also described herein for providing assistance to robots (e.g., robotic employees) in in an environment (e.g., a store, a warehouses, a factory, etc.). Robotics has become an essential part of modern operations, including in the retail industry, for operations in a warehouse or factor, among others. In one illustrative example, retail robots (e.g., robotic employees) are promising due to their ability to free up workers (e.g., human employees) from their routine tasks. These routine tasks may include merchandise (e.g., product) replenishment and/or replacement. When employing expensive hardware and complex algorithms, robots can be capable of interpreting the retail environment of a store, and reconstructing a plan-o-gram for the store. As such, a robot can be able to find its way from a located in a warehouse area located inside of the retail store to the exact shelf in the retail space of the store for replenishing and/or replacing products (e.g., commercial goods) that are out of date or expired.

However, robots need to be able to compute the path to the goods and to locate the goods by themselves, which can require the need for expensive hardware and/or location systems. Expensive hardware and/or location systems can result in a high cost for the robot. Even when employing expensive sophisticated robots, due to the complexity of the layout of the retail store, the path computed by these robots can be incorrect or inaccurate and, thus, the efficiency for replenishment and/or replacement of products can be impacted. As such, an improved technique, which is low cost and efficient, for assisting robots for replacing and/or replenishing products within a store can be very useful.

In one or more aspects, the systems and techniques can provide assistance to robots (e.g., robotic employees) in stores (or warehouses) for replacing and/or replenishing items (products) within the stores by utilizing wireless communication devices, such as ESLs. In one or more examples, The systems and techniques can provide for a low cost and efficient solution employing an ESL infra-structure (e.g., an ESL system) to navigate robots to complete routine tasks, such as replenishment and/or replacement of products within a retail store (or warehouse). In one or more examples, the wireless communication devices (e.g., ESLs) can display navigation images (e.g., such as images which may be in the form of a QR code) to one or more robots within a store to guide the robot(s) throughout the store to quickly and efficiently replenish and/or replace products within the store. The systems and techniques have the benefit of not needing the robot to have an on-boarded location system or any other kind of autonomous location system, which can be expensive. For the systems and techniques, a vision system on-boarded onto robot can be sufficient.

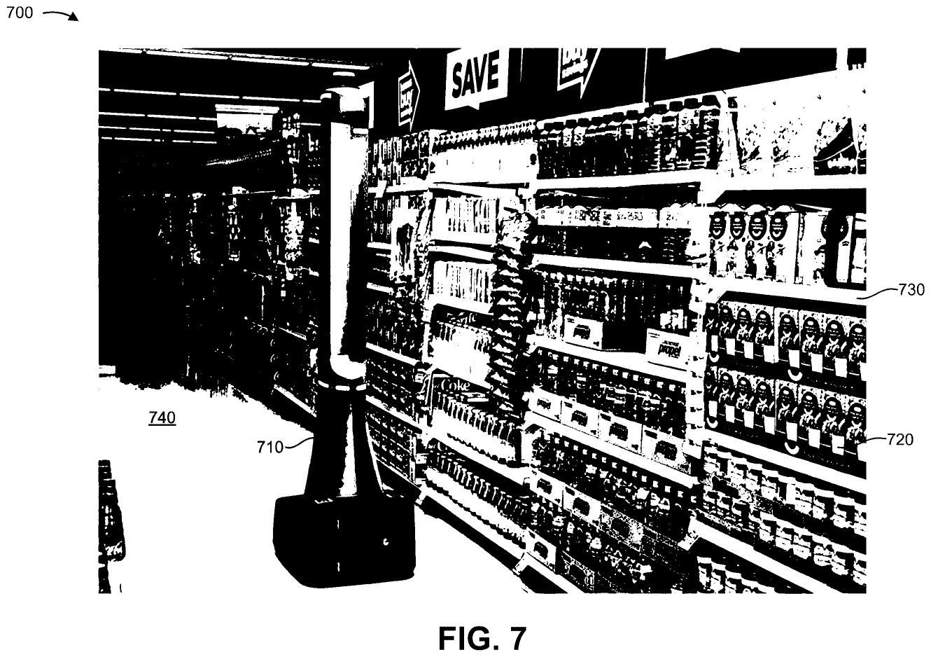

FIG. 7 shows an example of a retail store environment with a robot (e.g., robotic employee). In particular, FIG. 7 is a diagram illustrating an example of a retail store environment 700 with a robot 710 that may be provided assistance by using wireless communication devices, such as ESLs 720. In FIG. 7, the retail store environment 700 is shown to include an aisle 740 flanked by shelving units, each containing a plurality of shelves 730. Products are shown to be displayed on the shelves 730 of the shelving units. Each of the shelves 730 includes a plurality of ESLs 720 mounted to the shelves 730. In FIG. 7, the ESLs 720 are shown to be employed as product shelf labels to identify the products located on the shelves 730 above the respective tags along with a price for purchase of the products.

In one or more examples, the shelves 730 can each contain a rail controller that the ESLs 720 can be attached to such that the rail controller can provide power to the ESLs 720. The ESLs 720 each include a display screen (e.g., containing electronic-ink), which can describe the name of the product and the price of the product. The display screen of each of the ESLs 720 can be capable of displaying multiple different images. During operation, an ME (e.g., software running on a cloud server) can send instructions to the ESLs 720 to switch (update) to display different images, which can be stored within the memory of the ESLs 720. Replenishment and/or replacement of products on the shelves 730 typically occurs (e.g., with the assistance of the robots) during the time the store is closed and most, if not all, of the employees are off work.

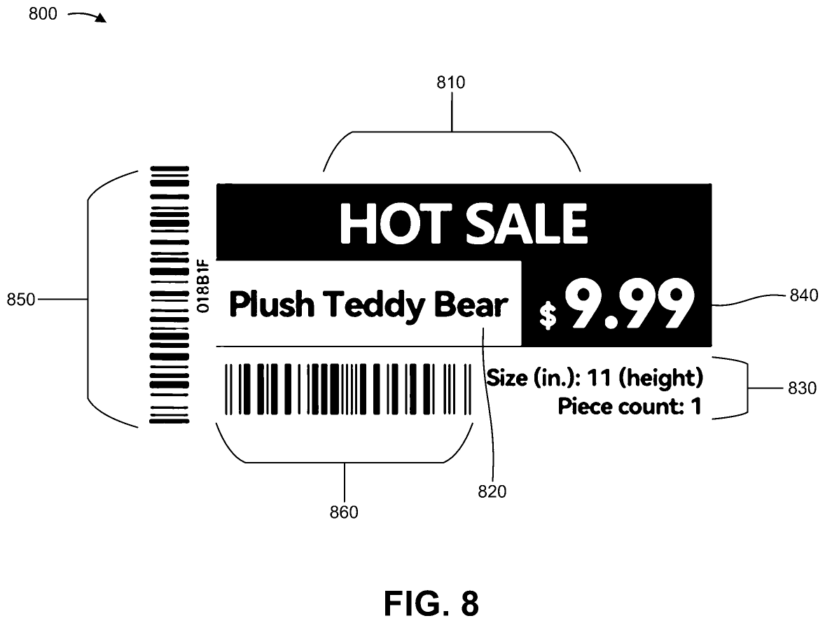

FIG. 8 shows an example of an ESL 800. In particular, FIG. 8 is a diagram illustrating an example of a wireless communication device in the form of an electronic shelf label (ESL) 800. In FIG. 8, the ESL 800 is shown to include a display that can display a heading 810 for the product, a name 820 of the product, a description 830 for the product, a price 840 for the product, and bar codes 850, 860. The heading 810 for the product may include any text related to the product to capture the user's attention, such as a notification of a sale on the price of the product. The description 830 of the product may include a description of the size, weight, and/or quantity of the package for the product. The bar code 850 may be associated with information for the shelf and/or shelving unit housing the product. The bar code 860 may be associated with information for the product itself (e.g., for purchase of the product, and may include the price and stock keeping unit (SKU) for the product).

In one or more examples, during operation for replenishment and/or replacement of products, an ME can transfer (e.g., transmit) navigation images including navigation information (e.g., path information) to every ESL in the store, for later fulfillment. The images can include a coded image (e.g., QR code) that is associated with coded instructions, which can be read by a robot. The QR code can provide coded instructions (e.g., turtle graphics) to the robot instructions regarding a path to be traveled to reach the next target (e.g., next ESL) and to arrive at a location in the store where fulfillment (e.g., replenishment and/or replacement) of products is to be provided (e.g., to a location on a particular shelf, of a particular shelving unit, in a certain aisle of the store). The instructions may be instructions that sequentially indicate to the robot how to move (e.g., move 10 units, rotate 30 units, and move 5 units). The instructions can be based on any type of programming language that can cause directions to be output for a robot and/or other device to follow from the point it is observing. In one illustrative example, the instructions may be turtle graphics coded using a logo programming language.

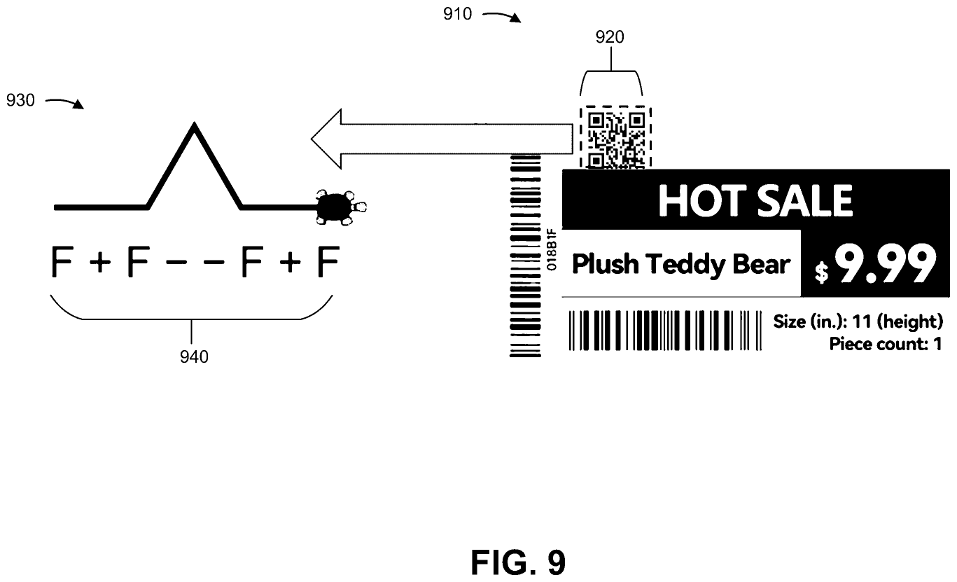

FIG. 9 shows an example of an ESL that includes a coded image (e.g., QR code) that can provide coded instructions (e.g., turtle graphics) to a robot for replenishment and/or replacement of products within a store. In particular, FIG. 9 is a diagram illustrating an example of a wireless communication device in the form of an ESL 910 including a coded image 920 (e.g., QR code) for providing assistance (e.g., to a robot for replenishment and/replacement of products). In FIG. 9, the ESL 910 is shown to be similar to the ESL 800 of FIG. 8, except the ESL 910 of FIG. 9 additionally includes a coded image 920. When a robot scans the coded image 920 (e.g., QR code) on the ESL 910, the robot will be able to read coded instructions 930 provided by the coded image 920. The coded instructions 930 can be of various different types of machine language instructions (e.g., turtle graphics). In FIG. 9, the coded instructions 930 are shown to include turtle graphics 940, which may be coded using a logo programming language.

Since the ME has knowledge of the plan-o-gram of the store and where the robots are located (e.g., typically, when the store opens, the robots are located in the warehouse area of the retail store), when products need to be replenished or replaced, the ME can compute (e.g., in the cloud using cloud resources) the most optimum path for the robot to travel to efficiently replenish or replace the products. After the ME has determined the optimum path, the ME can command (e.g., instruct) the ESLs located within close proximity to the robot to display directions (e.g., navigation images) to guide the robot accordingly. In one or more examples, the shelves in the store may have weight sensors attached such that when the weight sensors sense no weight on one or more of the shelves, the ME can be aware that the products on those particular shelves are out-of-stock and need to be replaced.

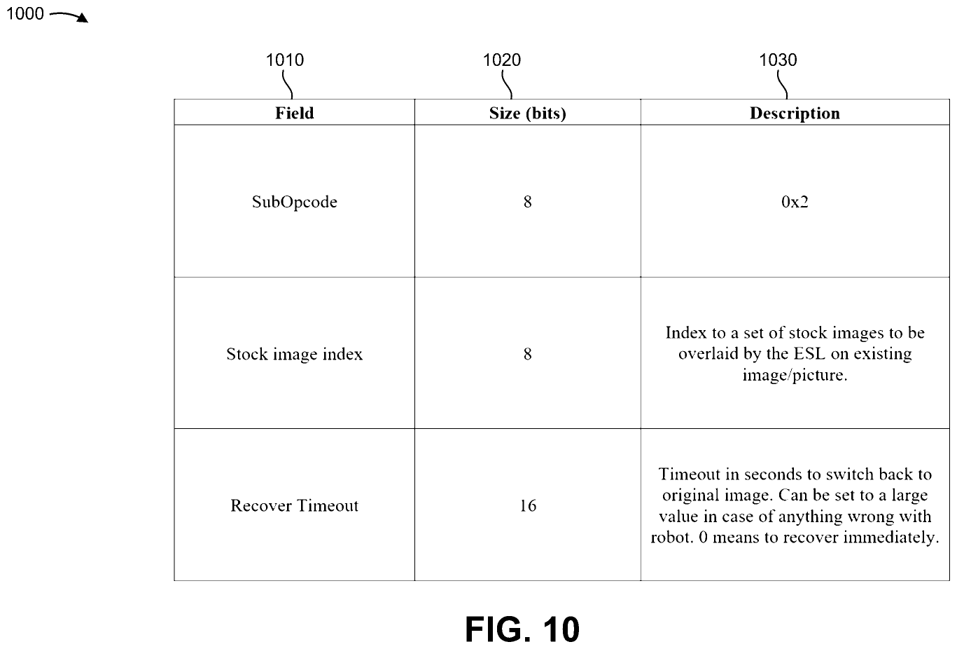

In one or more examples, the navigation images (e.g., coded images, such as QR codes) stored within the ESLs can be commanded (e.g., instructed) by an ME to be displayed (and/or switched) by using an operational code (opcode) (e.g., opcode 0×4F) with additional parameters. FIG. 10 shows examples of parameters 1010 for an opcode that may be used by an ME to command the ESLs to display the navigation images. In FIG. 10, the table 1000 is shown to include columns including parameters 1010 for the opcode, a size 1020 for each of the parameters 1010, and a description 1030 for each of the parameters 1010.

In one or more examples, the parameters 1010 may include a “SubOpcode” with a size 1020 of eight (8) bits and value of 0×2. The parameters 1010 may also include a “Stock image index,” with a size 1020 of 8 bits. The Stock image index can include an index for a particular navigation image within a set of stock navigation images that can be displayed or be overlaid onto an existing picture (e.g., image) being displayed by an ESL. Parameters 1010 can further include a “Recover Timeout,” with a size 1020 of 8 bits. The Recover Timeout can be a timeout (e.g., in seconds) to switch back to an original image. For example, the Recover Timeout can be set to a large value in case there are robot errors in reading the navigation image (e.g., a setting of 0 indicates for the navigation image to be immediately recovered onto the ESL).

After the ESLs, located within close proximity to a robot, display navigation images (e.g., coded images, such as QR codes), the robot can follow the instructions to move to the location where products need to be replenished or replaced. During the navigation process for the replenishment and/or replacement of products, a robot can provide feedback regarding the progression (e.g., the state) of the navigation process to the system (e.g., provide feedback to an ME in the ESL system, which can be done when the robot is onboarded onto the ESL system), when the robot has reached and read an ESL displaying a navigation image for the robot to follow. In one or more examples, after receiving feedback from a robot, the ME can restore on an ESL a navigation image, which may have timed-out and is no longer being displayed by the ESL, by setting the “Recover Timeout” field of the opcode to zero (0).

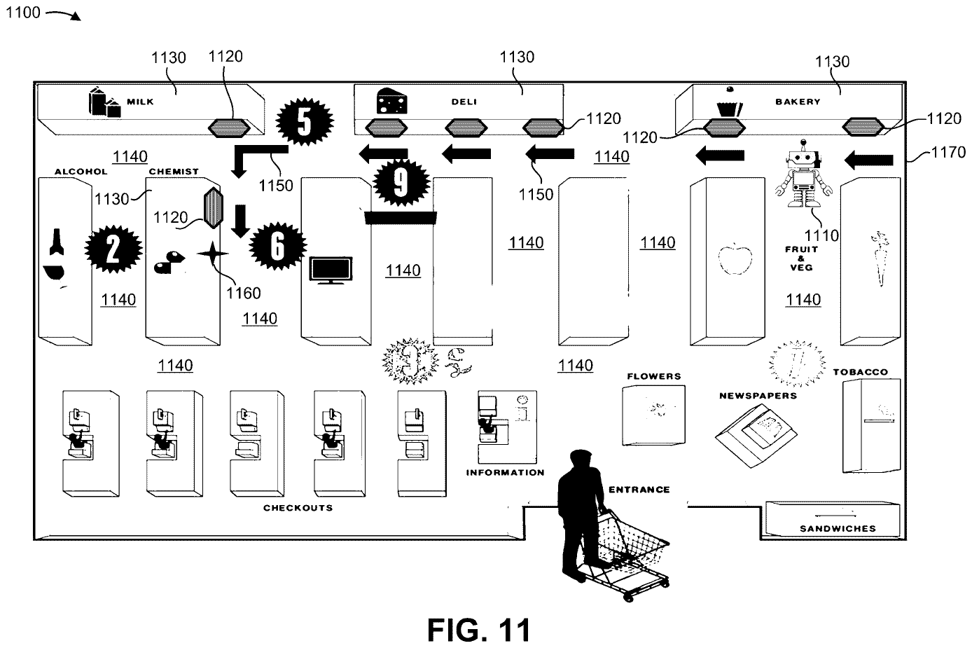

FIG. 11 shows an example of a robot following navigation images (e.g., coded images) displayed on ESLs to locate a target area 1160 (e.g., on shelves) where products need to be replenished and/or replaced. In particular, FIG. 11 is a diagram illustrating an example of a retail store 1100 employed with wireless communication devices, such as ESLs 1120, to provide assistance to a robot 1110 for replenishment and/or replacement of products. In FIG. 11, the store 1100 is shown to include a plurality of aisles 1140 flanked by shelving units 1130. ESLs 1120 are shown to be mounted on the shelving units 1130. The ESLs 1120 are mounted on shelves, of the shelving units 1130, below products housed on the shelves.

During operation for replenishment and/or replacement of products on the shelves of the shelving units 1130, the ESLs 1120 can display navigation images (e.g., coded images, such as QR codes), when the robot 1100 is located within close proximity of the ESLs 1120. The navigation images can define a path for the robot 1110 to follow from the warehouse area 1170 of the store 1100 to the location of the target area 1160 for replenishment and/or replacement of products (e.g., cough syrup) for the shelves associated with the target area 1160. An ESL located at the target area 1160 can blink (e.g., flash) its light emitting diode (LED) to indicate to the robot 1110 that the products for the particular shelf of that ESL need to be replenished or replaced. After the robot 1110 has finished replenishing or replacing the products at the target area 1160, the ME can determine (e.g., calculate) a new path for the robot 1110 to follow to perform another replenishment and/or replacement of products, or to proceed back to warehouse area 1170 of the store 1100.

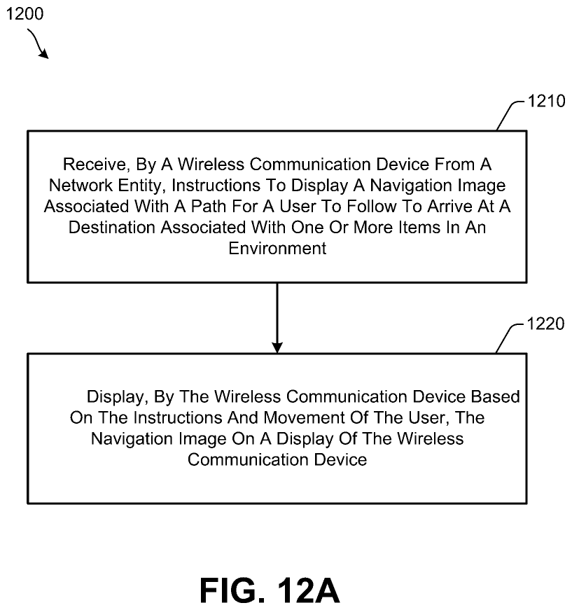

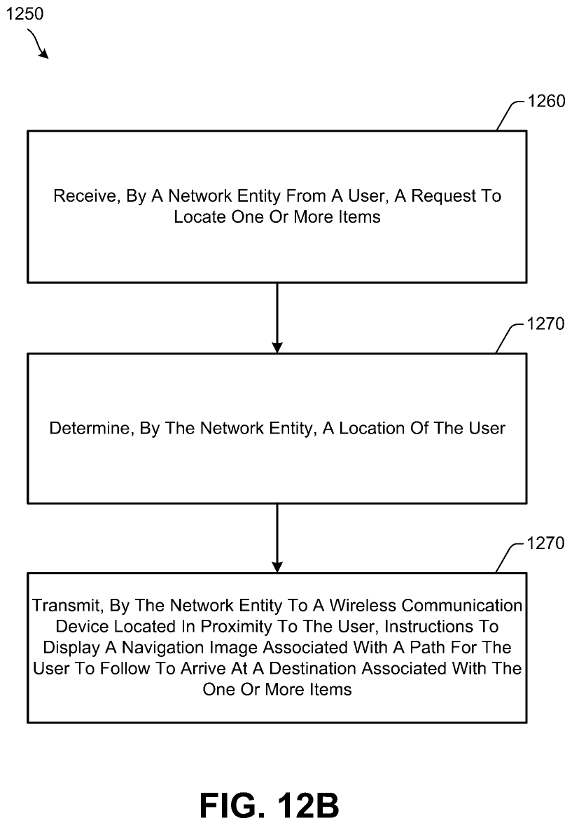

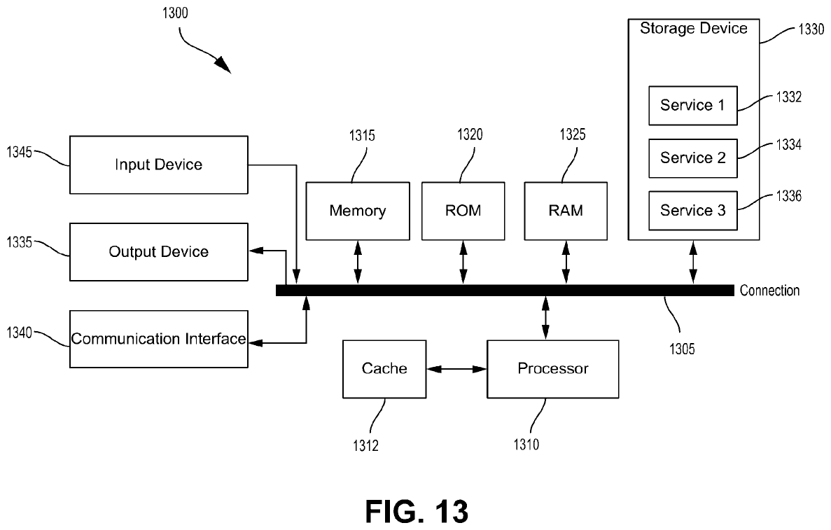

FIG. 12A is a flow chart illustrating an example of a process 1200 for providing assistance using wireless communication devices. The process 1200 can be performed by a wireless communication device (e.g., an ESL or other peripheral device, such as wireless communication device 120 of FIG. 1, the ESL 910 of FIG. 9, or other wireless communication device) or by a component or system (e.g., a chipset) of the wireless communication device. The operations of the process 1200 may be implemented as software components that are executed and run on one or more processors (e.g., processor 210 of FIG. 2, processor 1310 of FIG. 13, or other processor(s)). Further, the transmission and reception of signals by the wireless communications device in the process 1200 may be enabled, for example, by one or more antennas and/or one or more transceivers, such as one or more wireless transceiver(s) (e.g., communication component 235 of FIG. 2, communication interface 1340 of FIG. 13, or other antenna and/or transceiver).

At block 1210, the wireless communication device (or component thereof) can receive, from a network entity, instructions to display a navigation image associated with a path for a user to follow to arrive at a destination associated with one or more items in an environment. In one illustrative example, the network entity is a management entity (ME) (e.g., the ME 130 of FIG. 1). The user can be a person (e.g., the user described with respect to FIG. 4, FIG. 5, and/or FIG. 6) or a robot (e.g., the robot described with respect to FIG. 7, FIG. 8, FIG. 9, FIG. 10, and/or FIG. 11). The one or more items can include one or more products, one or more persons, one or more features of a building, any combination thereof, and/or other items.

At block 1220, the wireless communication device (or component thereof) can display, based on the instructions and movement of the user, the navigation image on a display of the wireless communication device. In some aspects, the wireless communication device (or component thereof) can display the navigation image on the display periodically or aperiodically. In some cases, the wireless communication device stores preloaded data (e.g., prior to the wireless communication device being deployed in the environment) including the navigation image. In some aspects, the wireless communication device (or component thereof) can cease displaying the navigation image based on the user reaching the destination.

In some examples, the navigation image includes one or more direction symbols, one or more coded images (e.g., the coded image 920 of FIG. 9), and/or other navigation image(s). In one illustrative example, the direction symbol(s) can include one or more direction symbol code (e.g., one or more of the direction symbol codes 510, 520, 530, or 540 of FIG. 5) associated with the user and/or a color associated with the user. In another illustrative example, the coded image is a quick response (QR) code (e.g., the coded image 920 of FIG. 9, which is illustrated as a QR code). In some cases, the coded image is associated with coded instructions that can be read by a robot (e.g., coded instructions 930 provided by the coded image 920 of FIG. 9).

FIG. 12B is a flow chart illustrating an example of a process 1250 for providing assistance using wireless communication devices. The process 1250 can be performed by a network entity (e.g., the management entity (ME) 130 of FIG. 1, or other network entity) or by a component or system (e.g., a chipset) of the network entity. The operations of the process 1250 may be implemented as software components that are executed and run on one or more processors (e.g., processor 210 of FIG. 2, processor 1310 of FIG. 13, or other processor(s)). Further, the transmission and reception of signals by the wireless communications device in the process 1250 may be enabled, for example, by one or more antennas and/or one or more transceivers, such as one or more wireless transceiver(s) (e.g., communication component 235 of FIG. 2, communication interface 1340 of FIG. 13, or other antenna and/or transceiver).

At block 1260, the network entity (or component thereof) can receive, from a user device, a request to locate one or more items. Referring to FIG. 6 as an illustrative example, the user device 630 can send the request 640 (e.g., based on a user providing input to the user device 630) to the ME 610 for navigating to locate a desired item.

At block 1270, the network entity (or component thereof) can determine a location of the user device (and thus a user of the user device). Referring again to FIG. 6 as an illustrative example, upon receiving the request and any other additional information from the user device 630, the ME 610 can obtain (e.g., determine) the location 655 of the user device 630. The network entity can determine the location of the user device using any suitable location method. In one illustrative example, the network entity can determine the location of the user device by obtaining the location of the user device the user device through the use of one or more positioning technologies (e.g., based on a global positioning system (GPS), global navigation satellite system (GNSS), etc.). For instance, the network entity can receive a GPS or GNSS location of the user device from the user device or from a GPS/GNSS server. In another illustrative example, the network entity can determine the location of the user device by using sensors located at various different positions within the store (e.g., by triangulating a location of the mobile device using signals from the sensors). In another illustrative example, the network entity can determine the location of the user device based on the user scanning a barcode or QR code on an ESL (or multiple barcodes or QR codes on multiple ESLs) using the user device. In such an example, the network entity can obtain a known location of the ESL (or ESLS) on which the barcode or QR code was scanned using the user device, and can use the known location of the ESL (or ESLs) as the location of the user device (and thus the user of the user device). The location can be known based on where the various ESLs were placed in the environment, which can be stored in the ME or another device (e.g., a server) accessible by the ME.

At block 1280, the network entity (or component thereof) can transmit, to a wireless communication device located in proximity to the user, instructions to display a navigation image associated with a path for the user to follow to arrive at a destination associated with the one or more items. In some cases, the network entity can assign a particular direction symbol code (or multiple direction symbol codes) to the user device, which correspond to the navigation image associated with the instructions. For instance, again referring to FIG. 6 as an illustrative example, the ME 610 can assign a direction symbol code 660 to the user device 630 (e.g., in scenarios where the ME 610 receives requests from multiple different users). The ME 610 can request 665 corresponding ESLs 620 (e.g., ESLs located in close proximity to the user device 630) to display direction symbols (e.g., navigation images) indicating one or more directions for the user device 630 to travel to locate the desired item. The ME 610 can update the ESLs 620 (e.g., ESLs located in close proximity to the user device 630) to display the directions (e.g., navigation images) periodically or aperiodically 670 based on the user's 630 movement. For instance, as the user moves through the environment, each ESL along the user's path can display a particular direction (or multiple directions in some cases) during a period of time during which the user is in proximity to the ESL. In some cases, the network can cause the wireless communication devices to stop displaying the directions, such as once the user is no longer in proximity to the wireless communication devices and/or once the user has reached the destination. For instance, the ME 610 of FIG. 6 can cause the ESLs 620 to stop displaying the directions (e.g., navigation images) at operation 675 (e.g., by sending an instruction to the ESLs directly or via an AP), once the user device 630 has passed each ESL and/or once the user has reached the destination location of the desired item.

The wireless communication device may include various components, such as one or more input devices, one or more output devices, one or more processors, one or more microprocessors, one or more microcomputers, one or more cameras, one or more sensors, one or more receivers, transmitters, and/or transceivers, and/or other component(s) that are configured to carry out the steps of processes described herein.

The components of the wireless communication device configured to perform the process 1200 of FIG. 12 can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

The process 1200 is illustrated as a logical flow diagram, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the process 1200 and/or other process described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 13 is a block diagram illustrating an example of a computing system 1300, which may be employed by the disclosed systems and techniques for providing assistance using wireless communication devices, such as ESLs. In particular, FIG. 13 illustrates an example of computing system 1300, which can be, for example, any computing device making up internal computing system, a remote computing system, a camera, or any component thereof in which the components of the system are in communication with each other using connection 1305. Connection 1305 can be a physical connection using a bus, or a direct connection into processor 1310, such as in a chipset architecture. Connection 1305 can also be a virtual connection, networked connection, or logical connection.

In some aspects, computing system 1300 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example system 1300 includes at least one processing unit (CPU or processor) 1310 and connection 1305 that communicatively couples various system components including system memory 1315, such as read-only memory (ROM) 1320 and random access memory (RAM) 1325 to processor 1310. Computing system 1300 can include a cache 1312 of high-speed memory connected directly with, in close proximity to, or integrated as part of processor 1310.

Processor 1310 can include any general purpose processor and a hardware service or software service, such as services 1332, 1334, and 1336 stored in storage device 1330, configured to control processor 1310 as well as a special-purpose processor where software instructions are incorporated into the actual processor design. Processor 1310 may essentially be a completely self-contained computing system, containing multiple cores or processors, a bus, memory controller, cache, etc. A multi-core processor may be symmetric or asymmetric.

To enable user interaction, computing system 1300 includes an input device 1345, which can represent any number of input mechanisms, such as a microphone for speech, a touch-sensitive screen for gesture or graphical input, keyboard, mouse, motion input, speech, etc. Computing system 1300 can also include output device 1335, which can be one or more of a number of output mechanisms. In some instances, multimodal systems can enable a user to provide multiple types of input/output to communicate with computing system 1300.

Computing system 1300 can include communications interface 1340, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth ™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

The communications interface 1340 may also include one or more range sensors (e.g., LIDAR sensors, laser range finders, RF radars, ultrasonic sensors, and infrared (IR) sensors) configured to collect data and provide measurements to processor 1310, whereby processor 1310 can be configured to perform determinations and calculations needed to obtain various measurements for the one or more range sensors. In some examples, the measurements can include time of flight, wavelengths, azimuth angle, elevation angle, range, linear velocity and/or angular velocity, or any combination thereof. The communications interface 1340 may also include one or more Global Navigation Satellite System (GNSS) receivers or transceivers that are used to determine a location of the computing system 1300 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1330 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L#) cache), resistive random-access memory (RRAM/ReRAM), phase change memory (PCM), spin transfer torque RAM (STT-RAM), another memory chip or cartridge, and/or a combination thereof.

The storage device 1330 can include software services, servers, services, etc., that when the code that defines such software is executed by the processor 1310, it causes the system to perform a function. In some aspects, a hardware service that performs a particular function can include the software component stored in a computer-readable medium in connection with the necessary hardware components, such as processor 1310, connection 1305, output device 1335, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories can include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

Claim language or other language reciting “at least one processor configured to,” “at least one processor being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Illustrative aspects of the disclosure include:
Aspect 1. A wireless communication device for wireless communication, the wireless communication device comprising: a display; at least one memory; and at least one processor coupled to the at least one memory and the display, the at least one processor is configured to: receive, from a network entity, instructions to display a navigation image associated with a path for a user to follow to arrive at a destination associated with one or more items in an environment; and based on the instructions and movement of the user, cause the display to display the navigation image.
Aspect 2. The wireless communication device of Aspect 1, wherein the wireless communication device is an electronic shelf label (ESL).
Aspect 3. The wireless communication device of any one of Aspects 1 or 2, wherein the network entity is a management entity (ME).
Aspect 4. The wireless communication device of any one of Aspects 1 to 3, wherein the user is one of a person or a robot, and wherein the one or more items are one of one or more products, one or more persons, or one or more features of a building.
Aspect 5. The wireless communication device of any one of Aspects 1 to 4, wherein the at least one processor is configured to cause the display to cease display of the navigation image based on the user reaching the destination.
Aspect 6. The wireless communication device of any one of Aspects 1 to 5, wherein the navigation image comprises at least one of a direction symbol or a coded image.
Aspect 7. The wireless communication device of Aspect 6, wherein the direction symbol comprises at least one of a direction symbol code associated with the user or a color associated with the user.
Aspect 8. The wireless communication device of any one of Aspects 6 or 7, wherein the coded image is a quick response (QR) code.
Aspect 9. The wireless communication device of any one of Aspects 6 to 8, wherein the coded image is associated with coded instructions.
Aspect 10. The wireless communication device of any one of Aspects 1 to 9, wherein the at least one memory is configured to store preloaded data comprising the navigation image.
Aspect 11. The wireless communication device of any one of Aspects 1 to 10, wherein the at least one processor is configured to cause the display to display the navigation image periodically or aperiodically.
Aspect 12. A method of wireless communication performed at a wireless communication device, the method comprising: receiving, by the wireless communication device from a network entity, instructions to display a navigation image associated with a path for a user to follow to arrive at a destination associated with one or more items in an environment; and displaying, by the wireless communication device based on the instructions and movement of the user, the navigation image on a display of the wireless communication device.
Aspect 13. The method of Aspect 12, wherein the wireless communication device is an electronic shelf label (ESL).
Aspect 14. The method of any one of Aspects 12 or 13, wherein the network entity is a management entity (ME).
Aspect 15. The method of any one of Aspects 12 to 14, wherein the user is one of a person or a robot, and wherein the one or more items are one of one or more products, one or more persons, or one or more features of a building.
Aspect 16. The method of any one of Aspects 12 to 15, further comprising ceasing displaying, by the wireless communication device, the navigation image based on the user reaching the destination.
Aspect 17. The method of any one of Aspects 12 to 16, wherein the navigation image comprises at least one of a direction symbol or a coded image.
Aspect 18. The method of Aspect 17, wherein the direction symbol comprises at least one of a direction symbol code associated with the user or a color associated with the user.
Aspect 19. The method of any one of Aspects 17 or 18, wherein the coded image is a quick response (QR) code.
Aspect 20. The method of any one of Aspects 17 to 19, wherein the coded image is associated with coded instructions.
Aspect 21. The method of any one of Aspects 12 to 20, wherein the wireless communication device comprises preloaded data comprising the navigation image.
Aspect 22. The method of any one of Aspects 12 to 21, further comprising displaying the navigation image on the display of the wireless communication device periodically or aperiodically.
Aspect 23. A non-transitory computer-readable storage medium of a wireless communication device comprising instructions stored thereon which, when executed by at least one processor, causes the at least one processor to perform operations according to any of Aspects 12 to 22.
Aspect 24. An apparatus comprising one or more means for performing operations according to any of Aspects 12 to 22.
Aspect 25. A network entity for wireless communication, the network entity comprising: at least one memory; and at least one processor coupled to the at least one memory and configured to: receive, from a user device, a request to locate one or more items; determine a location of the user device; and output, for transmission to a wireless communication device located in proximity to the user, instructions to display a navigation image associated with a path for the user to follow to arrive at a destination associated with the one or more items.
Aspect 26. A method of wireless communication performed at a network entity, the method comprising: receiving, by the network entity from a user device, a request to locate one or more items; determining, by the network entity, a location of the user device; and transmitting, by the network entity to a wireless communication device located in proximity to the user, instructions to display a navigation image associated with a path for the user to follow to arrive at a destination associated with the one or more items.
Aspect 23. A non-transitory computer-readable storage medium of a wireless communication device comprising instructions stored thereon which, when executed by at least one processor, causes the at least one processor to: receive, from a user device, a request to locate one or more items; determine a location of the user device; and output, for transmission to a wireless communication device located in proximity to the user, instructions to display a navigation image associated with a path for the user to follow to arrive at a destination associated with the one or more items.
Aspect 24. An apparatus comprising: means for receiving, from a user device, a request to locate one or more items; means for determining a location of the user device; and means for transmitting, to a wireless communication device located in proximity to the user, instructions to display a navigation image associated with a path for the user to follow to arrive at a destination associated with the one or more items.

Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.”

1. A wireless communication device for wireless communication, the wireless communication device comprising:
a display;
at least one memory; and
at least one processor coupled to the at least one memory and the display, the at least one processor is configured to:
receive, from a network entity, instructions to display a navigation image associated with a path for a user to follow to arrive at a destination associated with one or more items in an environment; and
based on the instructions and movement of the user, cause the display to display the navigation image.

2. The wireless communication device of claim 1, wherein the wireless communication device is an electronic shelf label (ESL).

3. The wireless communication device of claim 1, wherein the network entity is a management entity (ME).

4. The wireless communication device of claim 1, wherein the user is one of a person or a robot, and wherein the one or more items are one of one or more products, one or more persons, or one or more features of a building.

5. The wireless communication device of claim 1, wherein the at least one processor is configured to cause the display to cease display of the navigation image based on the user reaching the destination.

6. The wireless communication device of claim 1, wherein the navigation image comprises at least one of a direction symbol or a coded image.

7. The wireless communication device of claim 6, wherein the direction symbol comprises at least one of a direction symbol code associated with the user or a color associated with the user.

8. The wireless communication device of claim 6, wherein the coded image is a quick response (QR) code.

9. The wireless communication device of claim 6, wherein the coded image is associated with coded instructions.

10. The wireless communication device of claim 1, wherein the at least one memory is configured to store preloaded data comprising the navigation image.

11. The wireless communication device of claim 1, wherein the at least one processor is configured to cause the display to display the navigation image periodically or aperiodically.

12. A method of wireless communication performed at a wireless communication device, the method comprising:
receiving, by the wireless communication device from a network entity, instructions to display a navigation image associated with a path for a user to follow to arrive at a destination associated with one or more items in an environment; and
displaying, by the wireless communication device based on the instructions and movement of the user, the navigation image on a display of the wireless communication device.

13. The method of claim 12, wherein the wireless communication device is an electronic shelf label (ESL).

14. The method of claim 12, wherein the network entity is a management entity (ME).

15. The method of claim 12, wherein the user is one of a person or a robot, and wherein the one or more items are one of one or more products, one or more persons, or one or more features of a building.

16. The method of claim 12, further comprising ceasing displaying, by the wireless communication device, the navigation image based on the user reaching the destination.

17. The method of claim 12, wherein the navigation image comprises at least one of a direction symbol or a coded image.

18. The method of claim 17, wherein the direction symbol comprises at least one of a direction symbol code associated with the user or a color associated with the user.

19. The method of claim 17, wherein the coded image is a quick response (QR) code.

20. The method of claim 17, wherein the coded image is associated with coded instructions.

21-30. (canceled)
